(19) United States
(12) Patent Application Publication
(10) Pub. No.: US 2004/0119212 A1
(43) Pub. Date: Jun. 24, 2004

(54) Air spring cover and method of making the same

(76) Inventor: Jens-Uwe Gleu, Langenhagen (DE)

Correspondence Address: Walter Ottesen, Patent Attorney, P.O. Box 4026, Gaithersburg, MD, 20885-4026, US

(21) Appl. No.: 10/724,759

(22) Filed: Dec. 2, 2003

(30) Foreign Application Priority Data
Dec. 6, 2002 (DE) 102 57 009.4

(51) Int. Cl. F16F 5/00

(52) U.S. Cl. 267/64.11

(57) ABSTRACT

An air spring includes essentially an air spring cover (2), a rolling-lobe flexible member (9) and a roll-off piston which conjointly define a variable air spring space. Air springs are increasingly provided with an additional volume (4) in order to configure the spring performance more comfortably. For this purpose, the air spring cover (2) includes two shells (2a, 2b) which function as a housing for the wanted additional volume (4). The half-shells (2a, 2b) are especially deep drawn or injected air spring covers. To produce a cost effective, air-tight and high-strength connection of the two shells (2a, 2b), the shells (2a, 2b), which are to be connected, are connected by a flanging operation to each other or, the connection of the two shells (2a, 2b) is established by flange connecting a flanging clamp (10) over the common edge of the two shells. The flanging clamp (10) is made of a plastic deformable material.

### FIELD OF THE INVENTION

The invention relates to an air spring whose cover has an additional volume and a method for making the air spring.

### BACKGROUND OF THE INVENTION

A large volume in a given space available for mounting a component as well as the ensurance of accessibility is often difficult to realize without complicated air spring cover geometries having deep undercuts. Such an air spring cover can, as a rule, be realized by a partition in the transverse direction by two shells which must then be connected to each other air-tight and with high strength. The shells can, for example, be made by deep drawing. The invention is related to a cost effective, air-tight and high-strength connection of the deep-drawn half-shells.

The practice to date for connecting shell-shaped housing parts provides for a gas-tight welding or gluing with a subsequent helium leakage test. Welding or gluing as well as the subsequent leakage test is too complex for the manufacture of a mass produced article.

U.S. Pat. No. 4,659,070 describes an air spring suspension with a shock absorber and a primary air spring chamber which is assigned a further air chamber. The cylindrical housing parts are welded to each other over the entire peripheral region as described at column 3, starting at line 1.

U.S. Pat. No. 4,616,811 describes an air spring which likewise comprises a primary air chamber and an ancillary air chamber. Here too, the different cylindrical housing parts are welded to each other as described at column 3, starting at line 8.

In German patent publication 1,039,375 (corresponding to U.S. patent application Ser. No. 521,031, filed Jul. 11, 1955), an air spring is described for suspending motor vehicles. The cap-shaped parts of this suspension are welded to each other along the edge.

The air spring disclosed in U.S. Pat. No. 2,893,104 has a large volume. The edge of the vessel has a welded seam.

An air spring and shock absorber assembly is described in U.S. Pat. No. 6,237,902 having upper and lower parts which are welded to each other around the periphery.

In U.S. Pat. No. 3,700,225, an air spring and shock absorber assembly is disclosed wherein the housing and air spring cover are welded to each other.

From the above, it can be seen that the conventional method in air spring technology comprises making a weld seam for pressure-tight connecting different housing parts.

### SUMMARY OF THE INVENTION

It is an object of the invention to provide an air-tight and high-strength connection of two air spring cover half-shells in a cost effective manner. The half-shells are especially deep drawn half-shells.

The air spring of the invention includes: an air spring cover; a rolling-lobe flexible member attached to the air spring cover; the air spring cover including an upper part and a lower part delimiting an extra volume of the air spring; the upper and lower parts conjointly defining an interface whereat the parts are joined to each other; and, a pressure-tight and high-strength flanged seam formed at the interface.

Thus, according to a feature of the invention, the two parts are tightly connected to each other with a bent-over flange connection.

According to another feature of the invention, the parts, which are to be connected to each other, are tightly joined to each other by bending over a clamp made of a plastically deformable material. The clamp can, for example, be a steel ring.

The individual shells (the upper part and the lower part) can be manufactured by separate and optimized manufacturing methods such as by deep drawing, injection molding and casting.

An elastomeric part such as an O-ring can be inserted in the flanged seam itself or between the contact surfaces of the half-shells to improve an air-tight seal. With a suitable configuration of the elastomeric insert part, the connection can be used for insulating from vibrations.

The geometry of the parts, which are to be connected, need not be circular at the connecting interface; rather, the parts can be elliptical or can be otherwise configured.

The two half-shells can be made of different materials. The shells can also be made of a material which is not plastically deformable.

The bent-over clamp can be a purely cylindrical ring in the condition before mounting or the clamp can have a cross section which is already preformed to be concave. The flanged connection can be carried out very rapidly and cost effectively with an axial-forming process (press) or by a series of axial-forming processes. The flange connection can also be carried out by rolling.

In total, a cost effective manufacturing process results. A follow-up tightness check is not needed, that is, a considerable cost advantage is associated with the method of the invention. The method of the invention can be applied anywhere where hollow bodies are made which can be easily manufactured with the hollow body being partitioned.

### BRIEF DESCRIPTION OF THE DRAWINGS

The invention will now be described with reference to the drawings wherein:

FIG. 1 is a side elevation view, in section, of an air spring cover chamber wherein the edge of the upper shell to be flange connected is folded over; and,

FIG. 2 is a side elevation view, in section, of another embodiment showing an air spring cover wherein a separate clamp is flange connected at the interface of the upper and lower parts of the air spring cover.

### DESCRIPTION OF THE PREFERRED EMBODIMENTS OF THE INVENTION

An air spring includes a defined air spring volume which is closed air-tight by a cover 2, a rolling-lobe flexible member 9 and a roll-off piston (not shown). The rolling-lobe flexible member 9 is attached to the cover 2 by a clamp ring 7. In order to configure the suspension performance more comfortably, air springs are increasingly equipped with an additional volume 4. This additional volume 4 is disposed, for example, in the region of the air spring cover 2. For this purpose, the air spring cover 2 is made of two half-shells (2a, 2b) which function as a housing for the wanted additional volume 4. What is essential to the invention is the air-tight and high strength connection of the two half-shells (2a, 2b) to each other. These half-shells can be manufactured, for example, by deep drawing.

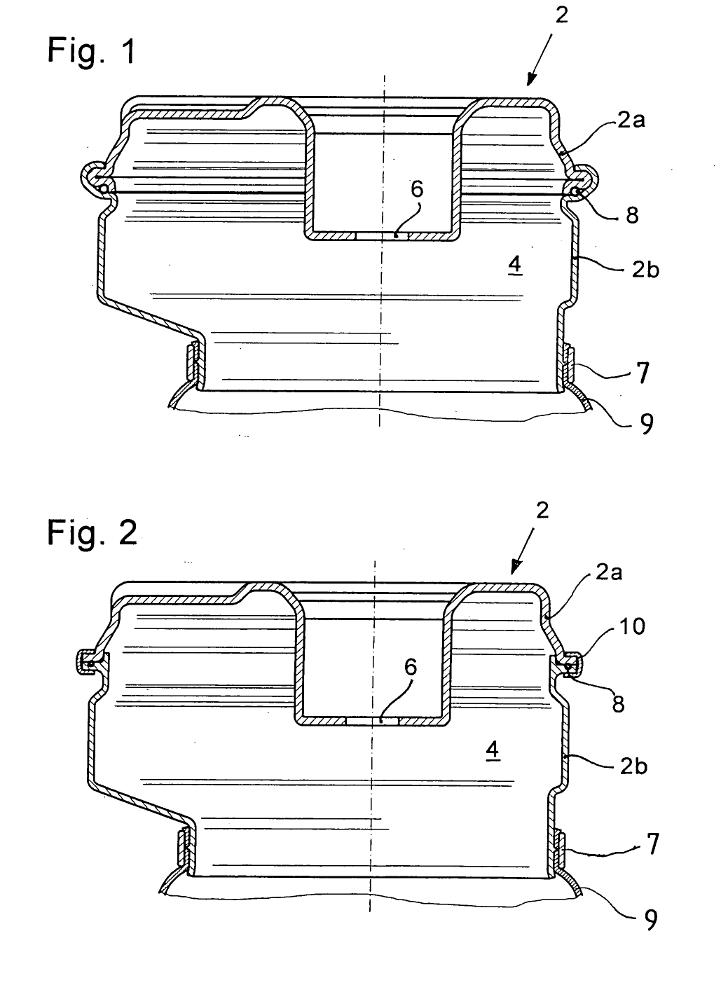

FIGS. 1 and 2 each show an air spring cover 2 comprising two half-shells (upper part 2a, lower part 2b). The two shells (2a, 2b) enclose additional volume 4. According to the invention, the two parts (2a, 2b), which are to be connected, are tightly connected to each other by a flanging operation.

In the embodiment of the air spring additional volume 4 shown in FIG. 1, the edge of the upper shell 2a, which is to be flanged, is folded over. Furthermore, the upper shell 2a includes an annular depression for accommodating an O-ring 8. The flanged edge of the lower shell 2b engages over the folded-over edge of the upper shell 2a as well as the O-ring 8. For example, by rolling, a pressure-tight and tension-tight connection of the two shells (2a, 2b) to each other is formed which then defines the additional volume 4.

In the alternate embodiment shown in FIG. 2, the upper part 2a and the lower part 2b are made of materials which permit another type of connection such as with threaded fasteners. The clamp 10 is bent-over to tightly connect the upper and lower parts (2a, 2b) with each other. The clamp 10 is made of a plastic deformable material and can, for example, be a steel ring. One of the contact surfaces of the half-shells (2a, 2b) includes a recess for accommodating an O-ring 8.

It is understood that the foregoing description is that of the preferred embodiments of the invention and that various changes and modifications may be made thereto without departing from the spirit and scope of the invention as defined in the appended claims.

What is claimed is:

1. An air spring comprising:
an air spring cover;
a rolling-lobe flexible member attached to said air spring cover;
said air spring cover including an upper part and a lower part delimiting an extra volume of said air spring;
said upper and lower parts conjointly defining an interface whereat said parts are joined to each other; and,
a pressure-tight and high-strength flanged seam formed at said interface.

2. The air spring of claim 1, further comprising a flange clamp at said interface.

3. The air spring of claim 1, wherein said flanged seam includes an annular depression; and, said air spring further comprises a sealing ring seated in said depression.

4. The air spring of claim 2, wherein one of said parts has a peripherally extending edge portion and said edge portion is folded over preparatory to being flanged over.

5. The air spring of claim 1, wherein said flanged seam has a circular form.

6. The air spring of claim 1, wherein said flanged seam has an elliptical form.

7. The air spring of claim 1, wherein said flanged seam has an uneven form.

8. The air spring of claim 1, wherein said upper and lower parts are made of respective materials different from each other.

9. The air spring of claim 2, wherein said flange clamp is a flat ring before being applied to said flanged seam.

10. The air spring of claim 2, wherein said flange clamp is preformed to have a cross section which is concave and to correspond to the form of said parts at said interface.

11. A method for connecting the upper and lower shell-like parts of a cover of an air spring, said upper and lower parts conjointly defining an interface, the method comprising the step of forming a flanged seam at said interface to fixedly and pressure-tight join said parts to each other.

12. The method of claim 11, wherein said first and second parts have respective edges which are joined to form said flanged seam; and, wherein the method comprises the further step of applying a clamp to said flanged seam with said clamp being made of a plastically deformable material.

13. The method of claim 11, the method comprising the further step of placing an elastomeric part in an annular depression at said interface in advance of forming said flanged seam.

14. The method of claim 11, wherein said flanged seam is realized by an axial forming process.

15. The method of claim 11, wherein said flanged seam is a rolled flanged seam.

16. The method of claim 11, wherein said upper and lower parts are produced in separate manufacturing processes.

17. The method of claim 11, wherein said upper and lower parts are made of a material which is not plastically deformed.
